(19) United States
(12) Patent Application Publication
(10) Pub. No.: US 2002/0124043 A1
(43) Pub. Date: Sep. 5, 2002

(54) Method of and system for withdrawing budget from a blocking task

(76) Inventors: Clara Maria Otero Perez, Eindhoven (NL); Elisabeth Francisca Maria Steffens, Eindhoven (NL); Reinder Jaap Bril, Eindhoven (NL)

Correspondence Address: U.S. Philips Corporation, 580 White Plains Road, Tarrytown, NY, 10591, US

(21) Appl. No.: 10/086,048

(22) Filed: Feb. 28, 2002

(30) Foreign Application Priority Data
Mar. 5, 2001 (EP) 01200810.8

(51) Int. Cl. G06F 9/00

(52) U.S. Cl. 709/107

(57) ABSTRACT

The method according to the invention detects a blocking task during a context switch performed by an underlying real-time operating system (406) and prevents the blocking task from running during the period in which the task blocked.

The invention relates to a method of scheduling a first task comprising the following steps:

a first step of starting the first task to run during a period,

a second step of detecting that the first task blocks during the period.

Furthermore the invention relates to a system for scheduling a first task comprising:

running means conceived to run the first task during a period,

detection means conceived to detect a blocking status of the first task.

An embodiment of the method of the kind set forth above is known from U.S. Pat. No. 6,108,683. Here, a user-level process scheduler is disclosed in a real-time class process scheduler space that can be used for multi media processing. The real-time class process scheduler is a fixed priority process scheduler that is supported by an operating system. The user-level process scheduler allocates CPU time to a user process and at the same time, the user-level process scheduler provides a blocking detection process that has a lower than or the same priority as the user process. When the user process is blocked due to input/output waiting, the user-level process scheduler allocates CPU time to the blocking detection process. Then, the blocking detection process detects an occurrence of blocking and posts this occurrence of blocking to the user-level process scheduler. By posting this occurrence, the user-level process scheduler recognizes that the execution of the user process is halted or stopped and the user-level process enables another user process to be executed. Additionally, the user-level process scheduler is notified by being posted a detected ready state when the state of the user process is changed into a ready or executable state indicating that the user process is able to execute. When the user-level process scheduler receives this notification representing the detection of the ready state, the user-level process scheduler allocates CPU time to the user process again.

It is an object of the current invention to provide a method as set forth above that handles a blocking state of a task in an improved way. To achieve this object, the method according to the invention is characterized in that the method further comprises a third step of preventing that the first task resumes running during the period. By preventing that the first task resumes running during the period in which it was detected that the first task blocks, it is prevented that other tasks may miss their deadlines. A deadline expresses a time stamp before which a task has to perform an amount of work within a period. The deadline can equal the end of a period. When a task does not meet its deadline within a period, the overall performance of a system can degrade. During the time that a task is blocked, other tasks can be prevented from making progress, which can result in these other tasks missing their deadlines too. In order to prevent that the blocking task interferes with other tasks, which can lead to the other tasks missing their deadlines, the blocking task is prevented from being resumed during the period in which it was blocked.

An embodiment of the method according to the invention is described in claim 2. By using context switch information, it is not necessary to provide a separate blocking detection task that must be scheduled by a real-time operating system or to provide a polling mechanism that, at predefined intervals, polls each task and queries whether it is blocked or not. The real-time operating system can perform a context switch in which a currently running task is suspended and another task is resumed. The real-time operating system can provide interfaces or hooks to link-in software that can be performed during this context switch. The linked-in software can then have access to information about the suspended and the resumed task during the context switch and use this information to detect whether the suspended task was blocking.

An embodiment of the method according to the invention is described in claim 3. By using context switch information, blocking of a task can be derived from available information and provided interfaces of the underlying real-time operating system in stead of adding additional interfaces or information to the task itself or to add a dedicated blocking detection task to the system. When, for example, Rate Monotonic Scheduling (RMS) is applied to schedule tasks, the priority of the task that is suspended and the priority of the task that is resumed can be used during the context switch. Within RMS, a task with a longer period has a lower priority than a task with a shorter period and scheduling of a task with a higher priority has precedence over a task with a lower priority. Each task is assigned a budget of the resources a task is allowed to consume during a period in order to meet its deadline for the period. When the task that is suspended during a period has a higher priority than the task that is resumed and the high priority task has not consumed its assigned budget for the period, then the suspended task is blocked.

An embodiment of the method according to the invention is described in claim 4. By withdrawing the remaining budget from the first, blocking, task, this first, blocking task is prevented from being resumed within the same period as within which it is suspended. Therefore, this first, blocking task does not cause other tasks to miss their deadlines. This results from conditions a task has to satisfy in order to be resumed during a period. One of these conditions is that the task must have a, remaining, budget to consume during the period. When a task has no remaining budget to consume during a period, an underlying real-time operating system does not resume the task to run during this period.

A further object of the invention is to provide a system as set forth above that handles a blocking state of a task in an improved way. To achieve this object, the system of scheduling a first task according to the current invention is characterized in that the system further comprises preventing means conceived to prevent that the first task resumes running during the period.

Embodiments of the system according to the invention are described in claim 6.

The invention will be described by means of embodiments illustrated by the following drawings:

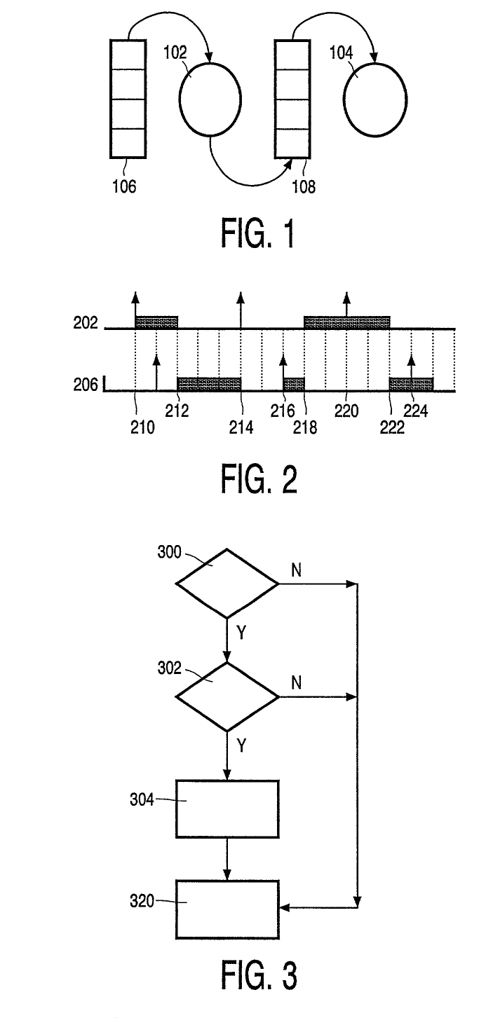

FIG. 1 illustrates a pipe-line or streaming architecture,

FIG. 2 illustrates a missing deadline of a task,

FIG. 3 illustrates the main steps of an embodiment of a method according to the invention,

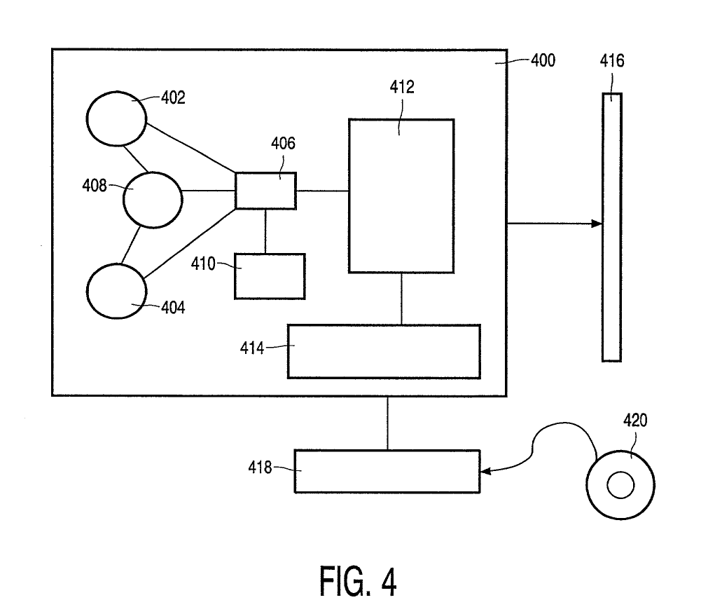

FIG. 4 illustrates the most important parts of an embodiment of the system according to the invention in a schematic way,

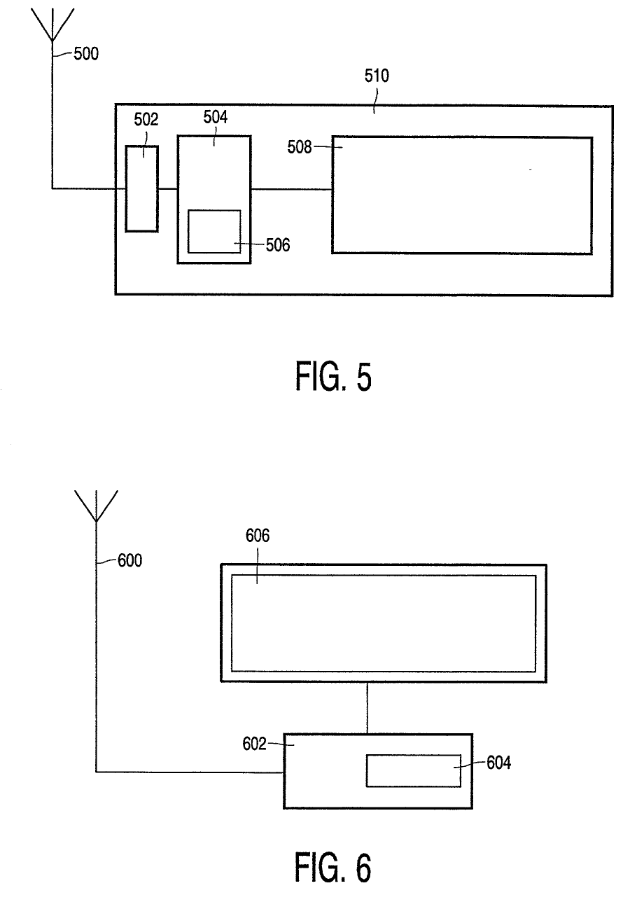

FIG. 5 illustrates a television set in a schematic way that contains an embodiment of the system according to the invention,

FIG. 6 illustrates a set-top box in a schematic way that contains an embodiment of the system according to the invention.

Nowadays, continuous media processing is performed more and more by programmable components, rather than dedicated single-function components. One of the characteristics of continuous media processing, such as is required for audio and video, is the presence of timing constraints also called deadlines. To handle such data appropriately, a system must observe the timing constraints and must guarantee sufficient system resources for processing. Since real time resources are finite, sufficient system resources may not be reserved for a particular processing session. This can lead to tasks missing their deadlines, which can result into a degradation of the performance of the system and a less than optimal utilization of the available resources.

Within high-quality video systems, a task can have a predefined number of periods during which it is allowed to run. Furthermore, all periods of a task can be of equal length and they can be consecutive. The budget of resources a task is allowed to consume during each of its periods is called a periodic budget. The periodic budgets of a task can be equal for each period or they can be different per period. Tasks can have deadlines indicating a time stamp before which a task must perform an amount of work within a period. Here, a deadline equals the end of a period. When a task does not meet its deadline within a period, the overall performance of a system can degrade.

An embodiment of the method according to the invention makes use of a, commercially available real-time operating system called pSOS. Other real-time operating systems that support fixed priority scheduling like VxWorks can be used too. The real-time operating system schedules the different tasks based on the priority of a task: a task with a higher priority takes precedence over a task with a lower priority. A task receives a priority based upon the fixed priority scheduling technique Rate Monotonic Scheduling (RMS). This means that a task with a longer period has a lower priority than a task with a shorter period. When two tasks have the same period, the task with the smaller budget gets the higher priority. The priority calculated this way is called the Rate Monotonic priority (RM). In order to allow a task to consume its budgets during a period, the priority of a task is raised to the RM priority. Once the budget is exhausted, the priority of the task is set to the background priority. The background priority is the lowest priority. When the priority of a task is set to the RM priority, its budget is enabled; when the priority of a task is set to the background priority, its budget is disabled.

The operating system enables the budgets and disables them. When a budget is enabled a task is resumed or enters the system. When a budget is disabled, a task is suspended or leaves the system. During a context switch performed by the operating system, a task enters while another task leaves the system. The operating system provides interfaces to link-in an embodiment of the method according to the invention that can be performed during the context switch. This enables programmers to extend the functionality of the underlying operating system. The extended functionality can be used to improve the performance of the system.

FIG. 1 illustrates an example of a pipe-line or streaming architecture in which tasks that perform continuous media processing, are linked to each other by queues. A task 102, retrieves its input date from its input queue 106, processes the input data and puts its resulting output data into its output queue 108. The output queue of a task 102 serves as the input queue its succeeding task 104. The input queue and output queue are bounded queues, which means that they have a limited capacity to hold data that can be processed by a task. Within this pipe-line or streaming architecture, a task can block when its input queue is empty or when its output queue is fall. This can occur when the task is working too fast or ahead. An embodiment of the method according to the invention as described below, prevents that a blocking task, for example task 102 interferes with the processing of a non-blocking task, for example task 104.

FIG. 2 illustrates an example of a deadline miss of a task. Here, task 202 is a periodic task with priority P₂₀₂, period T₂₀₂=5 and periodic budget B₂₀₂=2 and task 206 is a periodic task with priority P₂₀₂, period T₂₀₆=6 and periodic budget B₂₀₆=3. Task 202 is the high priority task, because its period is smaller than the period of task 206:

T₂₀₂<T₂₀₆=>P₂₀₂>P₂₀₆

Each task is ready to run at the beginning of its periods and it is therefore started to run at the beginning of a period. The arrow indicates the beginning of a period, Tᵢⱼ indicates the period T of task i for period j and Bᵢⱼ indicates the periodic budget B of task i for period j.

As is illustrated in FIG. 2, the task 202 starts at 210, because that is the start of its first period T_{202,1}. At 212, the task 202 has consumed its budget B_{202,1}. The real-time operating system pSOS suspends the task 202 and starts task 206 to run at 212. The second period T_{202,2} starts at 214. However, from 214 until 216, task 202 is blocked during which the task does not consume its periodic budget. The second period T_{202,2} of task 206 starts at 216. Since each task is ready to run at the beginning of its period and task 202 is blocked, task 206 starts running at 216. But at 218, task 202 is not blocked anymore and because the priority of 202 is higher than the priority of 206, task 202 pre-empts task 206 at 218. However, as can be derived from FIG. 2, at this moment task 206 has consumed a consumed budget CB_{206,2} that is less than its periodic budget B_{206,2}:

CB_{206,2}=1 and B_{206,2}=3=>CB_{206,2}<B_{206,2}

The remaining budget RB_{206,2} of task 206 is then:

RB_{206,2}=B_{206,2}−B_{206,2}=2.

The task 202 consumes its complete budget B_{202,2}. The next period T_{202, 3}of task 202 starts at 220 and because it is the beginning of the third period of task 202 and the priority of task 202 is higher than the priority of task 206, task 202 starts running at 220. When task 220 has consumed its complete budget B_{202,3}, task 202 is suspended and task 206 is started to consume its remaining budget RB_{206,2}. At 224 task 206 misses its deadline because the third period of task 206 starts before task 206 has consumed its remaining budget RB_{206,2}. The missing of a deadline of a task with a lower priority as a result of resuming a blocking task with a higher priority is prevented by the main steps of an embodiment of the method according to the invention as illustrated in FIG. 3.

FIG. 3 illustrates the main steps of an embodiment of the method according to the invention. Here, the periods of a task are of equal length, the periods are consecutive and the periodic budgets are equal. The method is performed during the context switch that is performed by the underlying operating system pSOS as previously described.

Within step 300, the priority of the task that leaves the system is checked against the priority of the task that is going to enter the system. When the priority of the task that leaves the system is lower than or equal to the priority of the task that enters the system, the task that enters the system is allowed to run and the method according to the invention gives back control to pSOS within step 320. When the priority of the task that leaves the system is higher than the priority of the task that enters the system, the budget of the leaving task is checked within step 302. The budget of the leaving task expresses the remaining budget that is not used by the task during the current period of the leaving task. When this remaining budget of the leaving task is equal to zero, the leaving task will not be allowed to run again by the underlying operating system. The task that enters the system is allowed to run and the method according to the invention gives back control to pSOS within step 320. When the remaining budget of the leaving task is greater than zero, the leaving task is blocking. The remaining budget of this leaving and blocking task is then decreased to zero within step 304. By decreasing the remaining budget of the leaving task to zero, the underlying operating system will not select the leaving task to operate again during the current period of the leaving task. After decreasing the remaining budget, the task that enters the system is allowed to run and the method according to the invention gives back control to pSOS within step 320.

The order in the described embodiment of the method of the current invention is not mandatory, a person skilled in the art may change the order of steps or perform steps concurrently using threading models, multi-processor systems or multiple processes without departing from the concept as intended by the current invention.

FIG. 4 illustrates the most important parts of an embodiment of the system according to the invention in a schematic way. The system 400 comprises a first memory 402 having computer-readable code embedded therein for performing a first task, for example decoding an image frame. A second memory 404 has computer-readable code embedded therein for performing a second task, for example applying image enhancement upon the decoded frame. The code of a real-time operating system, for example pSOS, is embedded into a third memory 406. The code of the real-time operating system has access to memory 410 that comprises the priorities, the assigned budgets and the periods of the first and the second task. Here, the first task is a periodic task with priority P₁, period T₁=5 and periodic budget B₁=2 and the second task is a periodic task with priority P₂, period T₂=6 and periodic budget B₂=3, as previously described. Furthermore, memory 410 comprises the elapsed time from the start of running the code embedded in the first memory 402 for performing the first task. The real-time operating system pSOS schedules the task on the basis of Rate Monotonic Scheduling. The period budgets B₁ and B₂ indicate the amount of CPU cycles of CPU 408, a task may use during a period when it's budget is enabled by the real-time operating system pSOS. The real-time operating system pSOS, fills the memory 412 with context switch information when it performs a context switch. Within a context switch, the priority and remaining budget of the task for which the budget is disabled and the priority and remaining budget of the task for which its budget is going to be enabled is put into memory 412. The memory 414 has computer-readable code embedded therein for retrieving the information from memory 412 and updating the remaining budget of the task for which the budget is disabled. When the retrieved information indicates that the task with the disabled budget is blocking as previously described, this blocking status is added to the contents of memory 412. The remaining budget of the task with the disabled budget is then set to zero and its priority is set to the background priority during the current period of the task by the real-time operating system pSOS. This system 400 is realized in software intended to be operated as an application by a computer or any other standard architecture able to operate software. The system can be used to operate a digital television set 416. The software can also be updated from a storage device 420 that comprises a computer program product arranged to perform the method according to the invention. The storage device is read by a CD reader 418 that is connected to the system 400.

FIG. 5 illustrates, in a schematic way, the most important parts of a television set 510 that comprises an embodiment of the system according to the invention. Here an antenna, 500 receives a television signal. The antenna may also be for example a satellite dish, cable, storage device, internet, Ethernet or any other device able to receive a television signal. A receiver, 502 receives the signal. The signal may be for example digital, analogue, RGB or YUV. Besides the receiver 502, the television set contains a programmable component, 504, for example a programmable integrated circuit. This programmable component contains a system according to the invention 506. A television screen 508 shows images that are received by the receiver 502 and are processed by the programmable component 504, the system according to the invention 506 and other parts that are normally contained in a television set, but are not shown here.

FIG. 6 illustrates, in a schematic way, the most important parts of a set-top box that comprises an embodiment of the system according to the invention. Here, an antenna 600 receives a television signal. The antenna may also be for example a satellite dish, cable, storage device, internet, Ethernet or any other device able to receive a television signal. A set-top box 602, receives the signal. The signal may be for example digital, analogue, RGB or YUV. Besides the usual parts that are contained in a set-top box, but are not shown here, the set-top box contains a system according to the invention 604. The television set 606 can show the output signal generated from a received signal by the set-top box 602 together with the system according to the invention 604. The output signal may also be directed to a storage device like a VCR, DVD-RW or a harddisk or they may be directed to an internet link in stead of being directed to the television set.

1. A method of scheduling a first task comprising the following steps:
a first step of starting the first task to run during a period,
a second step of detecting that the first task blocks during the period,
characterized in that the method further comprises:
a third step of preventing that the first task resumes running during the period.

2. The method of scheduling a first task according to claim 1, wherein the second step is based upon context switch information.

3. The method of scheduling a first task according to claim 2, wherein the second step of detecting that the first task blocks during the period comprises:
a first sub-step of detecting that the first task is suspended and that a second task is allowed to start running;
and wherein the context switch information comprises:
a second priority of the second task that is lower than a first priority of the first task, and
a remaining budget of the first task that is substantially equal to an assigned budget for the period minus a consumed budget during the period.

4. The method of scheduling a first task according to claim 3, wherein the remaining budget is withdrawn from the first task during the period.

5. A system for scheduling a first task (400) comprising:
running means (408) conceived to run the first task during a period,
detection means (412) conceived to detect a blocking status of the first task characterized in that the system further comprises:
preventing means (414) conceived to prevent that the first task resumes running during the period.

6. A system for scheduling a first task according to claim 5, wherein the detection means (412) is further conceived to operate on the basis of:
a first priority of the first task that is suspended,
a second priority of a second task that is resumed that is lower than the first priority of the first task,
a remaining budget of the first task that is substantially equal to an assigned budget for the period minus a consumed budget during the period.

7. A computer program product arranged to perform the method according to any of the claims 1 to 4.

8. A storage device (420) comprising a computer program product according to claim 7.

9. A television set (510) comprising a system according to claim 5 or 6.

10. A set-top box (602) comprising a system according to claim 5 or 6.
